(19) United States
(12) Patent Application Publication
(10) Pub. No.: US 2013/0199148 A1
(43) Pub. Date: Aug. 8, 2013

(54) Cutting Blade Method and Apparatus

(71) Applicant: Felix A. Goudeau, JR., Lafayette, LA (US)

(72) Inventor: Felix A. Goudeau, JR., Lafayette, LA (US)

(21) Appl. No.: 13/761,759

(22) Filed: Feb. 7, 2013

Related U.S. Application Data
(60) Provisional application No. 61/596,308, filed on Feb. 8, 2012.

(51) Int. Cl. A01D 34/73

(52) U.S. Cl. CPC A01D 34/73
USPC 56/295

(57) ABSTRACT

A rotary cutting blade for rotation about a fixed axis. The cutting blade has a generally rectangular planar body section having first and second ends and defining long and short edges. Each end of the cutting blade has both a downwardly oriented (leading) lifting and cutting member, and an upwardly oriented (trailing) lifting member. The downwardly oriented cutting member has a generally flat sharpened section oriented generally parallel to the plane orientation of the body section, and perpendicular to the rotational axis of the blade. The cutting blade can be re-sharpened without removal from a mower or other device.

### CROSS REFERENCES TO RELATED APPLICATION

Priority of U.S. Provisional Patent Application Ser. No. 61/596,308, filed Feb. 8, 2012, incorporated herein by reference, is hereby claimed.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains to a cutting blade for use on vegetation mowers including, without limitation, rotary, disk mowers and edgers. More particularly, the present invention pertains to a robust cutting blade having a plurality of cutting surfaces that provide improved cutting performance, durability and versatility.

2. Brief Description of the Prior Art

Existing cutting blades used on lawn mowers, edgers and the like are well known in the art. Such conventional cutting blades typically comprise a substantially rectangular planar body section having first and second ends, and defining long and short edges. At least one sharpened surface is generally disposed on said planar body section along at least a part of one long edge of said blade. In certain embodiments, a conventional cutting blade can also have an upwardly oriented “fin” on the opposite long side of said blade from said sharpened surface, directly across from a sharpened surface.

Such conventional cutting blades are typically installed on a rotary mower, edger or other similar apparatus well known to those having skill in the art. In operation, such conventional cutting blades are mounted under a protective blade guard and rotated or spun at high rotational speed about a fixed drive shaft attached to a drive motor. As such blade rotates or spins about said fixed shaft, a sharpened leading long edge cuts grass and/or other vegetation encountered by said leading edge using a slicing action. In order to facilitate such slicing action, conventional cutting blades are generally sharpened from the “top” (that is, the planar surface facing the mower) while the opposite planar surface (that is, the planar surface facing away from the mower) is substantially flat.

Although generally functional, said conventional cutting blades are often quick to dull as the leading sharpened edge surfaces contact vegetation, rocks or other debris. Such dulling can occur even after moderate use. As a conventional blade's leading sharpened edge(s) become dull or deformed during use, the blade's ability to slice grass and other vegetation degrades, resulting in substandard cutting performance. Such dull or damaged blades can also cause inefficient fuel use.

In order to improve cutting performance of dulled or damaged blades, conventional cutting blades must typically be sharpened and/or otherwise repaired. However, because the sharpened surfaces of such conventional blades are generally mounted in close proximity to a blade guard, such conventional blades must first be removed from a mower or other cutting apparatus in order to provide access to said sharpened surfaces. Moreover, such sharpening or repair must frequently be performed at a remote location or facility. Following sharpening or repair, such blades must then be re-installed. For this reason, sharpening and/or repair of conventional cutting blades can be a time consuming, labor-intensive and relatively expensive process.

Thus, there is a need for an improved cutting blade that can be used on existing mowers, edgers and/or other vegetation cutting devices. The improved cutting blade should improve cutting performance and durability while resisting dulling effects, particularly after moderate use. Importantly, the cutting blade should be capable of being sharpened while installed on a mower, edger or cutting apparatus without requiring removal and/or transportation to a remote location, thereby greatly reducing time, expense and manpower requirements associated with such sharpening process.

### SUMMARY OF THE INVENTION

The cutting blade of the present invention comprises a substantially rectangular and substantially planar body section having first and second ends, and defining long and short edges. In the preferred embodiment, each end of the cutting blade of the present invention has both a downwardly oriented (leading) cutting and lifting member, and an upwardly oriented (trailing) lifting member.

Said cutting blade of the present invention can be installed on a conventional rotary mower, edger or other similar apparatus well known to those having skill in the art. In operation, like conventional cutting blades, the cutting blade of the present invention is rotated or spun at high rotational speed about a drive shaft having a fixed axis. As such blade rotates or spins about said fixed axis, a leading long edge contacts (and cuts) grass and/or other vegetation encountered by said leading edge.

In the preferred embodiment, the cutting blade of the present invention has a substantially downwardly oriented leading edge member—a “dip tip”—at or near each end of said blade. Although the angles of said downwardly oriented leading edge members can be varied, it is to be observed that each such downwardly oriented leading edge member can be oriented at an acute angle, typically about 37.5 degrees, relative to the plane orientation of the body section of said blade.

At least one sharpened surface is disposed on each such downwardly oriented leading edge member of the cutting blade of the present invention. In the preferred embodiment, each such sharpened surface defines a substantially flat section that is oriented generally parallel to the plane orientation of the body section of said blade, and perpendicular to the rotational axis of said blade. As such, the blade of the present invention (and, more particularly, the sharpened surface of each downwardly oriented leading edge) cuts grass, vegetation and other materials using a scraping action rather than a slicing action. Such sharpened surface can be re-sharpened without removal from a mower or other device.

In the preferred embodiment, the cutting blade of the present invention also has a substantially upwardly oriented trailing edge member at or near each end of said blade, typically positioned opposite said downwardly oriented leading edge member. Although the angles of said upwardly oriented trailing edge members can be varied, it is to be observed that each such upwardly oriented trailing edge member can be oriented at an acute angle, typically about 37.5 degrees, relative to the plane orientation of the body section of said blade. However, the deflection angles of the upwardly and downwardly oriented edge members of the present invention can be varied for low-lift and high-lift embodiments.

All dimensions described or which can be inferred herein are illustrative only and should not be viewed as limiting in any way. Further, all blade dimensions include a metric equivalent to standard dimensions.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side view of a mower cutting blade of the present invention mounted to a conventional mower apparatus.

FIG. 2 depicts a perspective view of a mower cutting blade of the present invention.

FIG. 3 depicts a side sectional view of the mower cutting blade of the present invention along line 3-3 of FIG. 2.

FIG. 4 depicts a side sectional view of an alternative embodiment mower cutting blade of the present invention.

FIG. 5 depicts a side view of a mower cuffing blade of the present invention equipped with a mulching member mounted to a conventional mower apparatus.

FIG. 6 depicts a perspective view of a mower cutting blade of the present invention equipped with a mulching apparatus.

FIG. 7 depicts a side sectional view of the mower cutting blade of the present invention along line 7-7 of FIG. 6.

FIG. 8 depicts a side view of an alternative embodiment rotary blade of the present invention mounted to a conventional mower apparatus.

FIG. 9 depicts a perspective view of an alternative embodiment rotary blade of the present invention.

FIG. 10 depicts a side view of a second alternative rotary blade of the present invention mounted to a conventional mower apparatus.

FIG. 11 depicts a top view of a second alterative embodiment rotary blade of the present invention.

FIG. 12 depicts an exploded perspective view of a second alternative rotary blade of the present invention.

### DETAILED DESCRIPTION OF A PREFERRED EMBODIMENT

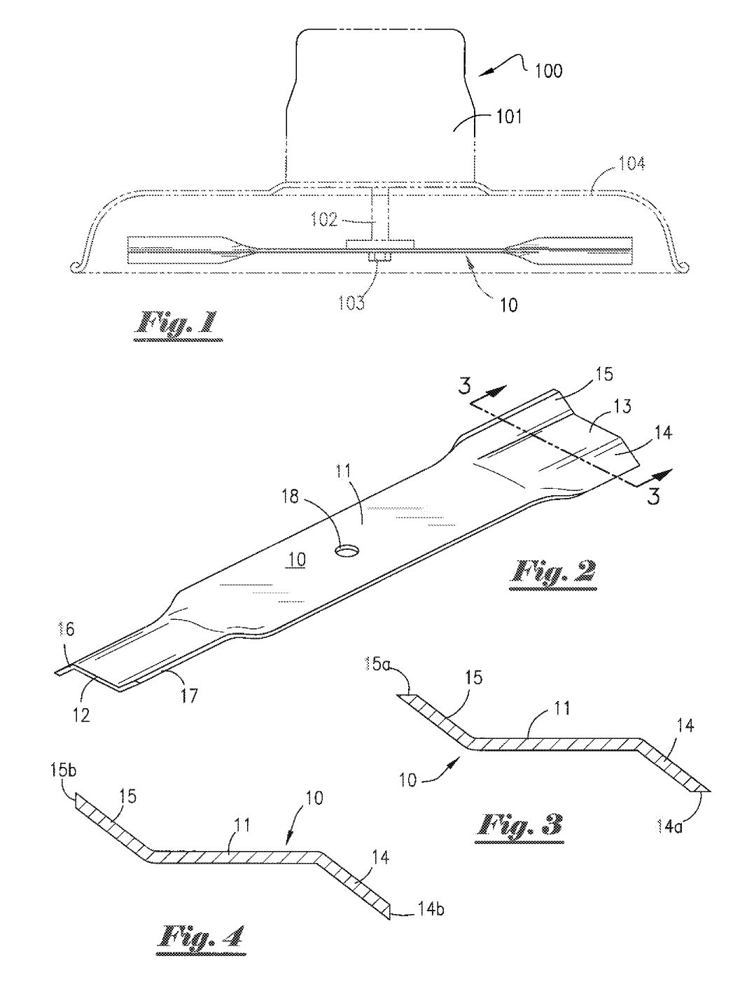

FIG. 1 depicts a side view of a cutting blade 10 of the present invention mounted to a conventional mower apparatus 100. As depicted in FIG. 1, conventional mower apparatus 100 comprises motor 101 having rotatable drive shaft 102. Blade guard 104 is disposed over cutting blade 10 and acts to protect users from said cutting blade 10, while providing a shield against flying debris generated by said cutting blade 10. Although cutting blade 10 of the present invention is depicted as being installed on conventional rotary mower apparatus 100 in FIG. 1, it is to be observed that said cutting blade 10 can be installed on an edger or other similar apparatus well known to those having skill in the art.

As with conventional cutting mower blades, cutting blade 10 of the present invention is mounted to drive shaft 102 using mounting nut 103 or other known attachment means. Said cutting blade 10 can be rotated or spun at high rotational speed about said drive shaft 102 which has a fixed axis. As cutting blade 10 rotates or spins about said fixed axis of drive shaft 102, said blade (or, more particularly, a leading long edge thereof) contacts and cuts grass and/or other vegetation.

FIG. 2 depicts a perspective view of cutting blade 10 of the present invention. Cutting blade 10 of the present invention comprises a substantially rectangular and substantially planar body section 11 having central bore 18 for attachment to a drive shaft (such as drive shaft 102 of mower apparatus 100 depicted in FIG. 1). Cutting blade 10 further has first end 12 and second end 13; in the embodiment depicted in FIG. 2, the substantially rectangular shape of cutting blade 10 defines two substantially parallel long edges and two substantially parallel short edges. However, it is to be observed that said cutting blade of the present invention can have other “non-rectangular” shapes without departing from the scope of the present invention.

Still referring to FIG. 2, cutting blade 10 of the present invention has both a downwardly oriented (leading) cutting and lifting planar member, and an upwardly oriented (trailing) lifting planar member. Specifically, cutting blade 10 of the present invention has a substantially downwardly oriented planar leading member 16 at end 12 of said blade, and a substantially downwardly oriented planar leading member 14 at end 13 of said blade. The angles of said downwardly oriented leading planar members can be adjusted to suit particular operational parameters or variables. However, it is to be observed that in the preferred embodiment each such downwardly oriented leading member 14 and 16 can be oriented at an acute angle, typically about 37.5 degrees, relative to the plane orientation of body section 11 of cutting blade 10. Further, each such downwardly oriented member 14 and 16 defines an outer or distal leading edge.

Similarly, in the preferred embodiment, cutting blade 10 of the present invention also has a substantially upwardly oriented planar trailing member 17 at end 12 of said blade 10, as well as upwardly oriented planar trailing member 15 at end 13 of said blade. Although the angles of said upwardly oriented planar trailing members 15 and 17 can be adjusted, it is to be observed that in the preferred embodiment each such upwardly oriented trailing member can be oriented at an acute angle, typically about 37.5 degrees, relative to the plane of body section 11 of cutting blade 10.

It is also to be observed that cutting blade 10, as depicted in FIGS. 1 through 4, is designed for clockwise rotation about a rotational axis, such as mower drive shaft 102 depicted in FIG. 1. Downwardly oriented member 16 at end 12 of cutting blade 10, and downwardly oriented member 14 at end 13 of said blade 10, are both disposed on leading edges of such blade 10 as said blade rotates in a clockwise direction. Moreover, upwardly oriented member 17 at end 12 of said blade 10, and upwardly oriented member 15 at end 13 of said blade 10, are both disposed on trailing edges of blade 10 when it rotates in a clockwise direction. In the event that an embodiment for counterclockwise rotation is desired, said blade can be manufactured with said upwardly and downwardly oriented members reversed at both ends, thereby allowing said downwardly oriented members to be on the leading edges during counterclockwise rotation of blade 10.

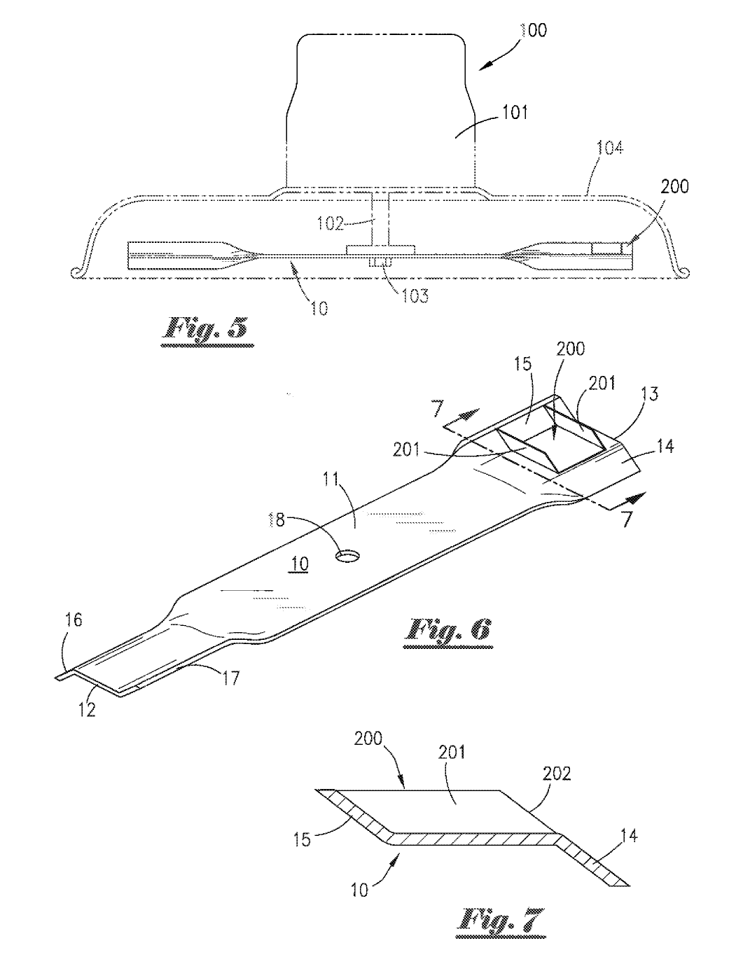

FIG. 3 depicts a side sectional view of cutting blade 10 of the present invention along line 3-3 of FIG. 2. At least one sharpened surface is disposed on an outer or distal edge of each such downwardly oriented member of the cutting blade 10 of the present invention. Specifically, referring to FIG. 3, sharpened surface 14a is formed on downwardly oriented leading edge member 14 of blade 10, while substantially flat surface 15a is formed on the upwardly oriented trailing edge member 15.

In the preferred embodiment, sharpened surface 14a defines a substantially flat surface oriented generally parallel to the plane orientation of body section 11 of said blade, and perpendicular to the rotational axis of said blade when mounted on a mower apparatus. As such, as blade 10 rotates and downwardly oriented member 14 encounters grass, vegetation and other materials, sharpened surface 14a (as well as a sharpened surface of downwardly oriented leading edge member 16, not shown in FIG. 3) lifts and cuts such grass, vegetation and other materials using a scraping action rather than a slicing action used by conventional cutting blades.

FIG. 4 depicts a side sectional view of an alternative embodiment cutting blade 10 of the present invention. In such alternative embodiment, each such sharpened surface (such as sharpened surface 14b of downwardly oriented leading edge member 14 in FIG. 4) defines a substantially flat surface oriented substantially perpendicular to the plane orientation of body section 11 of said blade, and substantially parallel to the rotational axis of said blade when mounted on a mower apparatus. As with sharpened surface 14a, alternative sharpened surface 14b can also be re-sharpened without removal of cutting blade 10 from a mower or other device.

FIG. 5 depicts a side view of a cutting blade 10 of the present invention equipped with a mulching member 200 mounted to a conventional mower apparatus 100. As depicted in FIG. 5, conventional mowing apparatus 100 comprises motor 101 having rotatable drive shaft 102 and blade guard 104 disposed over cutting blade 10. Cutting blade 10 of the present invention is mounted to drive shaft 102 using mounting nut 103 or other known attachment means. Mulching member 200 is mounted to the upper surface of cutting blade 10.

FIG. 6 depicts a perspective view of cutting blade 10 of the present invention equipped with mulching member 200. As previously noted, cutting blade 10 of the present invention comprises a substantially rectangular and substantially planar body section 11 having central bore 18 for attachment to a mower drive shaft, as well as first end 12 and second end 13. Cutting blade 10 has substantially downwardly oriented leading members 14 and 16 at ends 13 and 12, respectively, and upwardly oriented trailing member 15 and 17 at ends 13 and 12, respectively.

As depicted in FIG. 6, mulching member 200 forms a pair of opposing planar members 201 extending from cutting blade 10. In the preferred embodiment, said planar members 201 are oriented substantially parallel to each other and perpendicular to the plane orientation of body section 11 of said blade 10. Said mulching member 200 is beneficially disposed between said downwardly oriented leading member 14 and upwardly oriented trailing member 15 at end 13 of cutting blade 10. Mulching member 200 contacts grass cuttings, vegetation and/or other debris under blade guard 104, further chopping or mulching such materials.

Although a single mulching member 200 is depicted in FIG. 6, it is to be observed that multiple mulching members 200 can be installed on a single cutting blade; for example, a mulching member 200 can be installed on both the top and bottom of cutting blade 10 between downwardly oriented leading member 14 and upwardly oriented trailing member 15 near end 13, as well as the top and bottom of cutting blade 10 between downwardly oriented leading member 16 and upwardly oriented trailing member 17 near end 12.

FIG. 7 depicts a side sectional view of cutting blade 10 of the present invention along line 7-7 of FIG. 6. Mulching member 200 is mounted to the upper surface of cutting blade 10. As depicted in FIG. 7, said planar members 201 have ends 202 that are angled substantially consistent with the angles of said downwardly oriented leading member 14 and upwardly oriented trailing member 15.

FIG. 8 depicts a side view of alternative embodiment rotary blade 20 of the present invention mounted to a conventional mower apparatus 100. Conventional mower apparatus 100 comprises motor 101 having rotatable drive shaft 102 attached to pan member 105. Blade guard 104 is disposed over cutting blades 20. At least one cutting blade 20 of the present invention is mounted to pan 105 using mounting nuts 103 or other known attachment means.

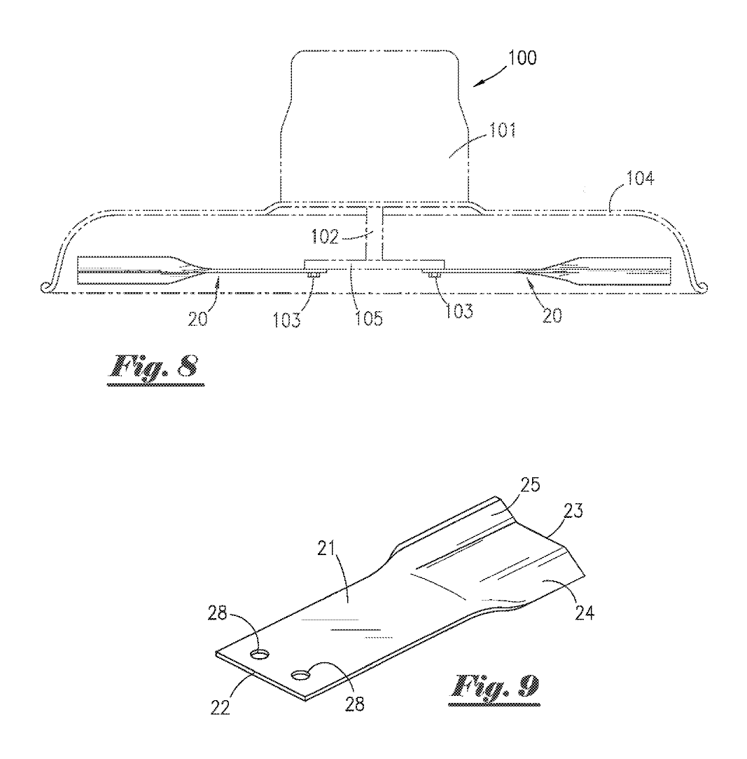

FIG. 9 depicts a perspective view of a rotary blade 20 of the present invention. Rotary cutting blade 20 of the present invention comprises a substantially rectangular and substantially planar body section 21 having bores 28 for attachment to a mower pan member, as well as first end 22 and second end 23. Cutting blade 20 has substantially downwardly oriented leading member 24 at end 23, and upwardly oriented trailing member 25 at end 23. The angles of said upwardly oriented member 25 and downwardly oriented member 24 can be adjusted to suit particular operational parameters or variables. However, it is to be observed that in the preferred embodiment each such upwardly and downwardly oriented member can be oriented at an acute angle, typically about 37.5 degrees, relative to the plane orientation of body section 21 of cutting blade 20.

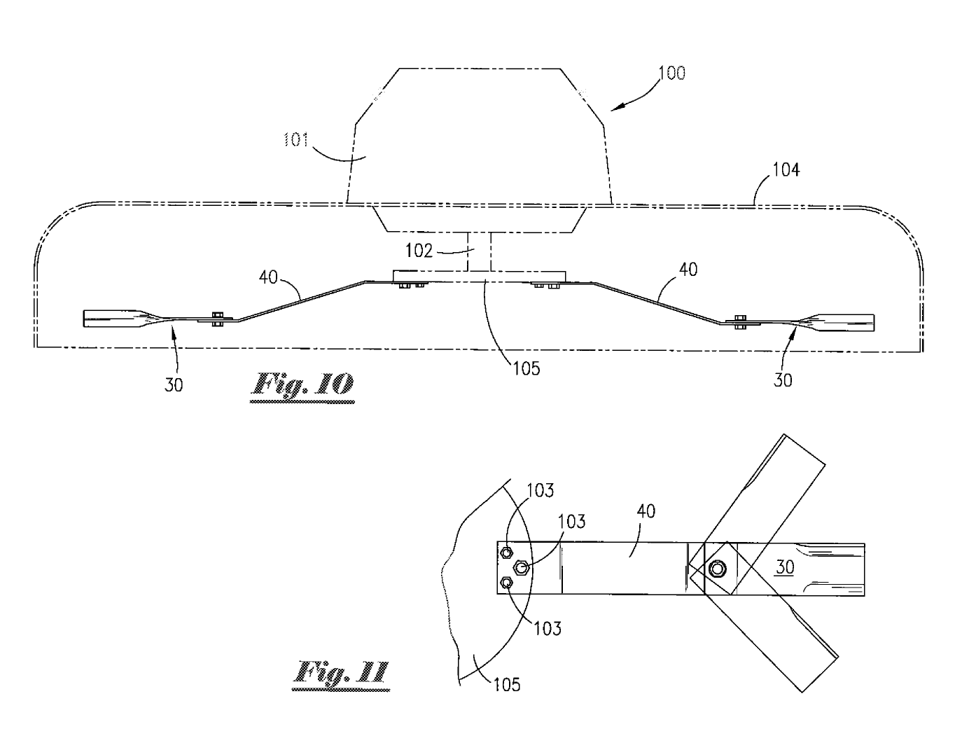

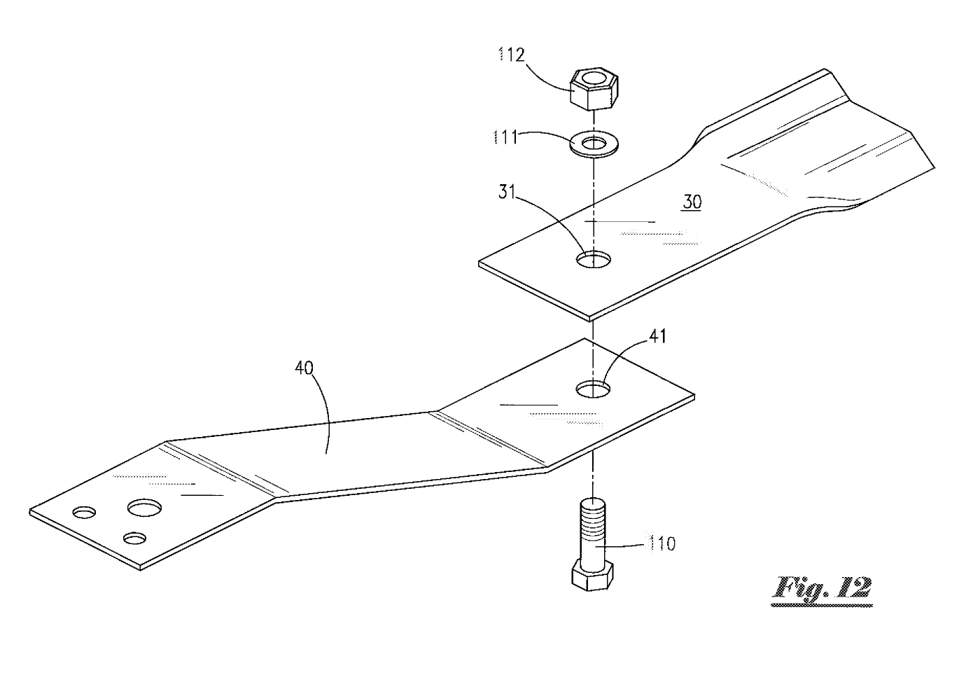

FIG. 10 depicts a side view of a second alternative embodiment offset rotary cutting blade 30 of the present invention mounted to a conventional mower apparatus 100. Conventional mower apparatus 100 comprises motor 101 having rotatable drive shaft 102 attached to pan member 105. Offset blade extension members 40 are attached to rotatable pan member 105. Blade guard 104 is disposed over offset blade extension members 40 and cutting blades 30. At least one cutting blade 30 of the present invention is pivotally mounted to each offset blade extension member 40.

FIG. 11 depicts a top view of second alternative embodiment offset rotary blade 30 of the present invention. Offset blade extension members 40 are attached at one end to rotatable pan member 105 using mounting nuts 103 or other similar known attachment means. Cutting blade 30 of the present invention is mounted to the opposite end of offset blade extension member 40 from pan member 105. In the preferred embodiment, said cutting blade 30 is pivotally mounted to said offset blade extension member 40, thereby allowing said cutting blade 30 to swing side-to-side about a fixed axis oriented substantially parallel to drive shaft 102.

FIG. 12 depicts an exploded perspective view of alternative embodiment offset rotary blade 30 of the present invention. In the preferred embodiment, said cutting blade 30 is pivotally mounted to said offset blade extension member 40; threaded bolt 110 is received within bore 41 of offset blade extension member 40 and bore 31 of cutting blade 30. Washer 111 and threaded nut 112 are received on said threaded bolt 110.

The cutting blades of the present invention can save time, expense and effort compared to conventional cutting blades. Unlike conventional cutting blades, the cutting blades of the present invention cannot be installed “upside down”. Regardless of which planar surface of a cutting blade of the present invention is installed facing toward a mower apparatus, the opposite planar side of said blade will be properly oriented for lifting and cutting. Moreover, if a new or different lifting and/or cutting surface is ever desired, a cutting blade of the present invention need only be removed, turned over, and re-installed on a mower apparatus.

Because of the configuration of the blades of the present invention, the sharpened surfaces of said blades (such as, for example, surfaces 14a and 15a of FIG. 3, and surfaces 14b and 15b of FIG. 4) can be easily accessed for sharpening or dressing without being removed from a mower apparatus. This feature is particularly beneficial on folding mower assemblies that provide easy access to cutting blades.

Conventional cutting blades are typically manufactured from a single piece of material. As such, when removal of a cutting blade is desired, the entire blade must generally be removed from a mower apparatus, By contrast, the cutting blade embodiments depicted in FIGS. 10 through 12 can be easily removed from an extension member and replaced with another cutting blade; however, removal of the extension member is not required simply to change a cutting blade. This results in much more efficient use of materials and reduction in waste.

In the preferred embodiment, a method of cutting blade replacement/trading can be established. After use, a dulled or worn cutting blade of the present invention can be returned (typically for a credit) to a central source and exchanged for a new or sharpened cutting blade, typically at much less cost than outright purchase of a new replacement blade. Because existing blades are recycled, waste associated with discarded blades is dramatically reduced.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A cutting blade adapted to rotate about a fixed axis comprising:
a. a substantially planar body member having a first end and a second end, and substantially parallel first and second sides; and
b. a downwardly extending planar member disposed along said first side and defining a distal edge, wherein said downwardly extending planar member is oriented at first acute angle relative to said planar body member and has a substantially flat surface along said distal edge.

2. The cutting blade of claim . wherein said first acute angle is approximately 37 degrees.

3. The cutting blade of claim 1, further comprising an upwardly extending planar member disposed along said second side, wherein said upwardly extending planar member is oriented at a second acute angle relative to said planar body member.

4. The cutting blade of claim 3, wherein said second acute angle is approximately 37 degrees.

5. A cutting blade adapted to rotate within a substantially horizontal plane about a substantially vertical axis comprising a substantially planar body member having a first end and a second end, and substantially parallel first and second sides, wherein a portion of said first side extends downwardly from said substantially planar body member at a first acute angle relative to said substantially horizontal plane.

6. The cutting blade of claim 5, wherein downwardly extending portion of said first side defines a distal edge oriented substantially parallel to said substantially horizontal plane.

7. The cutting blade of claim 5, wherein said first acute angle is approximately 37 degrees.

8. The cutting blade of claim 5, wherein a portion of said second side extends upwardly from said substantially planar body member at a second acute angle relative to said substantially horizontal plane.

9. The cutting blade of claim 8, wherein said second acute angle is approximately 37 degrees.

10. A cutting blade adapted to rotate within a substantially horizontal plane about a substantially vertical axis comprising a substantially planar body member having a first end and a second end, a first side and a second side, a bore adapted to receive a rotary shaft approximately equidistant between said first and second ends, and defining a first leading edge along said first side between said first end and said bore and a second leading edge along said second side between said second end and said bore, wherein a portion of said first and second leading edges extend downwardly from said substantially planar body member at a first acute angle relative to said substantially horizontal plane.

11. The cutting blade of claim 10, wherein downwardly extending portion of said first and second leading edges are oriented substantially parallel to said substantially horizontal plane.

12. The cutting blade of claim 10, wherein said first acute angle is approximately 37 degrees.

13. The cutting blade of claim 10, further comprising a first trailing edge between said first end and said bore and across said body member from said first leading edge, a second trailing edge between said second end and said bore and across said body member from said second leading edge, wherein a portion of said first and second trailing edges extend upwardly from said substantially planar body member at a second acute angle relative to said substantially horizontal plane.

14. The cutting blade of claim 13, wherein said second acute angle is approximately 37 degrees.
